(19) United States
(12) Patent Application Publication
(10) Pub. No.: US 2022/0293108 A1
(43) Pub. Date: Sep. 15, 2022

(54) CONTEXTUAL SPEECH-TO-TEXT SYSTEM

(71) Applicant: Genba, Inc., Seattle, WA (US)

(72) Inventors: Bruce Kaufman, Seattle, WA (US); Sean Robinson, Burien, WA (US); Emory Sullivan, Brooklyn, NY (US); Vaughn Koch, Seattle, WA (US); Kevin Leneway, Seattle, WA (US); Mickey Ristroph, Castle Rock, CO (US); Tyler Sellon, Seattle, WA (US)

(73) Assignee: Genba, Inc., Seattle, WA (US)

(21) Appl. No.: 17/694,433

(22) Filed: Mar. 14, 2022

Related U.S. Application Data
(60) Provisional application No. 63/160,557, filed on Mar. 12, 2021.

(51) Int. Cl. G10L 15/26; G10L 15/06; G10L 15/01; G10L 15/30

(52) U.S. Cl. CPC G10L 15/26; G10L 15/063; G10L 15/01; G10L 15/30; G10L 2015/0633

(57) ABSTRACT

Disclosed embodiments operate in conjunction with remote Speech-To-Text (STT) systems, extending and enhancing performance of these systems by using contextual systems to provide inputs to them, as well as correcting likely word errors in the output. These systems are combined to produce an end-to-end system with Word Error Rates significantly better than those available with remote STT systems alone.

### CROSS-REFERENCE TO RELATED APPLICATIONS

The present application claims the benefit of U.S. Provisional Application No. 63/160,557, filed Mar. 12, 2021, entitled “Contextual Speech-to-Text System,” the entire disclosure of which is hereby incorporated by reference herein for all purposes.

### SUMMARY OF THE DISCLOSURE WITH BACKGROUND INFORMATION

Speech-to-text (“STT”) systems are available from cloud services companies (e.g., Google, AWS, Microsoft Azure). Typically, these systems take in audio files with speech, and perform speech recognition, returning one or more potential transcript(s), often also returning the method's confidence in those transcripts at the word-level or phrase-level. These systems typically also allow for an additional vocabulary list to be inputted along with the audio, to allow unknown words to be added and detected, or words more likely to be present in the current context to be “boosted” to increase their relative confidence in the system and increase the likelihood of them appearing in the transcripts. Finally, often these systems feature several models trained on various sorts of data (clean, noisy, different encoding rates) that can be chosen to optimize the transcriptions.

These systems work reasonably well for transcription of common words and phrases, but struggle with uncommon words, words that don't appear in a lexicon (e.g., acronyms like RFID), words that are unique or proprietary to a specific organization (e.g., SlawNic23), and homonyms (e.g., Palette vs pallet), among other examples. These conventional STT systems also have a limited number of words that can be added as additional vocabulary. A large vocabulary set can also lead to false positives among that list, so carefully choosing this list is important to the operations of the STT system. As a result, the accuracy and trainability of these systems is limited, especially in situations that require the use of significant context-specific vocabulary.

There is an ongoing search for superior mechanisms and techniques to transform spoken language into textual content.

Embodiments of this disclosure are directed to a contextual STT platform (the “Genba platform”) that improves the accuracy, efficiency and impact of knowledge management for teams of people and individuals. The Genba platform implements technology over the full knowledge management cycle: (1) knowledge capture→(2) knowledge analysis→(3) knowledge delivery. Generally stated, the disclosed system evaluates documents and things used by an enterprise, which may have its own industry-specific lexicon, to identify words and phrases that are more prevalently used by that enterprise. Those words and phrases are stored in a contextual vocabulary and associated with the context in which the words and phrases are used. As users in the enterprise submit additional audio recordings, the disclosed system performs STT recognition on those audio recordings and include content from the contextual vocabulary to improve word error rates. The contextual vocabulary may also be used to perform automated transcript correction to select alternative word or phrase choices consistent with the context of the audio recording.

Taken together, these elements fundamentally improve the ability of software to accurately, efficiently and impactfully manage complex, contextual knowledge. This system is especially impactful for teams of distributed workers that must process high volumes of complex information daily, but the system can also provide significant value to individual users in other environments as well.

### BRIEF DESCRIPTION OF THE DRAWINGS

FIG. 1 is an illustrative hardware device in which may be implemented embodiments of a contextual speech-to-text system in accordance with the disclosure.

FIG. 2 is an illustrative computer network environment in which may be implemented embodiments of a contextual Speech-To-Text system in accordance with the disclosure.

FIG. 3 is an illustrative block diagram generally illustrating executable components of a contextual Speech-To-Text platform, in accordance with the disclosure.

FIG. 4 is a functional diagram generally illustrating a workflow 400 of operations in accordance with various preferred embodiments.

FIG. 5 is a flow diagram generally illustrating a process performed by various embodiments to accomplish contextual Speech-To-Text recognition, in accordance with the disclosure.

### DETAILED DESCRIPTION OF EMBODIMENTS

Generally described, the disclosure is directed at a mechanism and technique to achieve superior speech-to-text (STT) recognition by analyzing the speech in the context in which the speech is being captured, typically using a mobile device. A contextual vocabulary may be compiled and used to improve the accuracy of STT recognition. Machine learning based on user feedback may be employed to further enhance the accuracy. Preferred embodiments will now be described.

In the following detailed description, reference is made to the accompanying figures, which form a part hereof. In the figures, similar symbols typically identify similar components, unless context dictates otherwise. The illustrative embodiments described in this detailed description, the figures, and the claims are not meant to be limiting. Other embodiments may be used, and other changes may be made, without departing from the spirit and scope of the subject matter presented herein. It will be readily understood that aspects of the disclosure, as generally described herein, and illustrated in the figures, can be arranged, substituted, combined, separated, and designed in a wide variety of different configurations, all of which are explicitly contemplated herein.

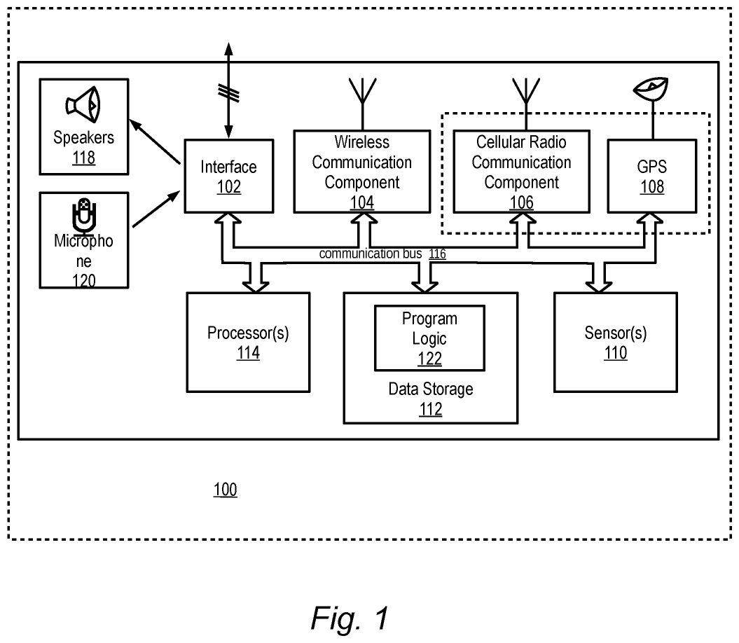

Turning now to the figures, FIG. 1 illustrates an example speech recognition device 100 that may be used in implementations of the disclosure. In some examples, components illustrated in FIG. 1 may be distributed across multiple devices. However, for simplicity of discussion, the components are shown and described as part of one example speech recognition device 100. The speech recognition device 100 may be incorporated in or include a mobile device (such as a mobile phone), desktop computer, laptop computer, email/messaging device, tablet computer, or similar device that may be configured to perform the functions described herein. Generally, the speech recognition device 100 may be implemented with any type of computing device that is configured to process data in accordance with methods and functions described herein.

In various embodiments, the speech recognition device 100 may include an interface 102, a wireless communication component 104, a cellular radio communication component 106, a global positioning system (GPS) receiver 108, sensor(s) 110, data storage 112, and processor(s) 114. The speech recognition device 100 may also include hardware to enable communication between the speech recognition device 100 and other computing devices (not shown), such as a server entity. The hardware may include transmitters, receivers, and antennas, for example.

The interface 102 may be configured to allow the speech recognition device 100 to communicate with other computing devices (not shown), such as a server. Thus, the interface 102 may be configured to receive input data from one or more computing devices, and may also be configured to send output data to the one or more computing devices. The interface 102 may be configured to function according to a wired or wireless communication protocol. In some examples, the interface 102 may include buttons, a keyboard, a touchscreen, speaker(s) 118, microphone(s) 120, and/or any other elements for receiving inputs, as well as one or more displays, and/or any other elements for communicating outputs.

The wireless communication component 104 may be a communication interface that is configured to facilitate wireless data communication for the speech recognition device 100 according to one or more wireless communication standards. For example, the wireless communication component 104 may include a Wi-Fi communication component that is configured to facilitate wireless data communication according to one or more IEEE 802.11 standards, or the like. As another example, the wireless communication component 104 may include a Bluetooth communication component that is configured to facilitate wireless data communication according to one or more Bluetooth standards, or the like. Other examples are also possible.

The cellular radio communication component 106 may be a communication interface that is configured to facilitate wireless communication (voice and/or data) with a cellular wireless base station to provide mobile connectivity to a network. The cellular radio communication component 106 may be configured to connect to a cellular tower proximate to the speech recognition device 100, for example.

The GPS receiver 108 may be configured to estimate a location of the speech recognition device 100 by precisely timing signals received from Global Positioning System (GPS) satellites.

The sensor(s) 110 may include one or more sensors, or may represent one or more sensors coupled to the speech recognition device 100. Example sensors include an accelerometer, gyroscope, pedometer, LIDAR or other optical sensors, microphone, camera(s), infrared flash, barometer, magnetometer, near field communication (NFC), projector, depth sensor, temperature sensor, or other location and/or context-aware sensors.

The data storage 112 (memory) may store program logic 122 that can be accessed and executed by the processor(s) 114. The data storage 112 may also store data collected by the interface 102, the sensor(s) 110, the wireless communication component 104, the cellular radio communication component 106, and/or the GPS receiver 108.

The processor(s) 114 may be configured to receive data collected by any of sensor(s) 110 and perform any number of functions based on the data. As an example, the processor(s) 114 may be configured to determine one or more geographical location estimates of the speech recognition device 100 using one or more location-determination components, such as the wireless communication component 104, the cellular radio communication component 106, or the GPS receiver 108. The processor(s) 114 may use a location-determination algorithm to determine a location of the speech recognition device 100 based on a presence and/or location of one or more known wireless access points within a wireless range of the speech recognition device 100.

The speech recognition device 100 may include more or fewer components. Further, example methods described herein may be performed individually by components of the speech recognition device 100, or in combination by one or all of the components of the speech recognition device 100.

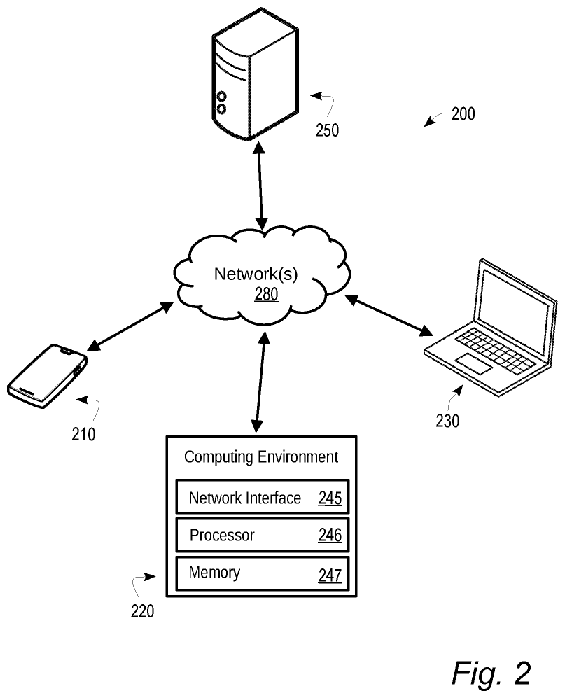

FIG. 2 is a block diagram of one embodiment of a networked computing environment 200 in which the disclosed technology may be practiced. Networked computing environment 200 includes a plurality of computing devices interconnected through one or more networks 280. The one or more networks 280 allow a particular computing device to connect to and communicate with another computing device. The depicted computing devices include computing device 220, mobile device 210, computer 230, and remote server 250. In various embodiments, the plurality of computing devices may include other computing devices not shown. The one or more networks 280 may include a secure network such as an enterprise private network, an unsecure network such as a wireless open network, a local area network (LAN), a wide area network (WAN), and the Internet. Each network of the one or more networks 280 may include hubs, bridges, routers, switches, and wired transmission media such as a wired network or direct-wired connection.

A server, such as remote server 250, may allow a client to upload and download information (e.g., text, audio, image, and video files) to and from the server, or to perform a search query related to particular information stored on the server. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

In accordance with this disclosure, remote server 250 includes speech-to-text (STT) recognition components that operate to convert audio data into textual data by digitizing captured audio sounds and analyzing those sounds to identify words. The remote server 250 may implement a remote STT service, such as those offered by Google, AWS, Microsoft Azure, or the like.

One embodiment of computing device 220 includes network interface 245, processor 246, and memory 247, all in communication with each other. Network interface 245 allows computing device 220 to connect to one or more networks 280. Network interface 245 may include a wireless network interface, a modem, and/or a wired network interface. Processor 246 allows computing device 220 to execute computer readable instructions stored in memory 247 to perform processes discussed herein.

Networked computing environment 200 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet and the underlying infrastructure it represents.

In one embodiment, remote server 250 may receive an audio file and one or more keywords from computing device 220. The remote server 250 may identify one or more speech sounds within the audio file associated with the one or more keywords. Subsequently, remote server 250 may adapt a cloud-based speech recognition technique based on the one or more speech sounds, perform the cloud-based speech recognition technique on the audio file, and return one or more words identified within the audio file to computing device 220.

### Embodiments of a Contextual STT Platform

In accordance with this disclosure is a contextual Speech-To-Text (“STT”) software platform (the “Genba platform”) that improves the accuracy, efficiency and impact of knowledge management for teams of people and individuals. The Genba platform implements technology over the full knowledge management cycle: (1) knowledge capture→(2) knowledge analysis→(3) knowledge delivery. Taken together, these elements fundamentally improve the ability of software to accurately, efficiently and impactfully manage complex, contextual knowledge. This system is expected to be especially beneficial for teams of distributed workers that process high volumes of complex information daily, but can also provide significant value to individual users in other environments as well. Embodiments may implement knowledge capture as provided in this disclosure.

Embodiments of the Genba platform extend ordinary STT interfaces by adding several pieces that act in concert to optimize the additional vocabulary list, structure the data returned from these interfaces, and replace common incorrect terms. It also includes a system to allow users to quickly add to these components as the system is used. These components fit together to allow reduced word error rates in a conventional environment where language may vary between contexts (industries, companies, facilities, jobs, individuals, etc.).

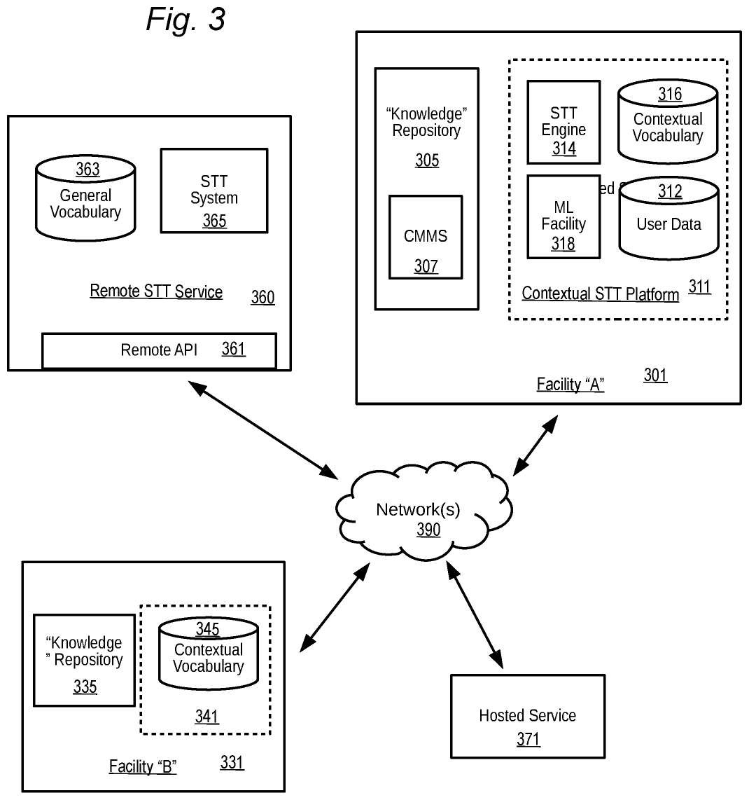

By way of illustration, FIG. 3 is an overview of an operating environment 300 showing exemplary components of a contextual STT platform. As illustrated, the operating environment 300 includes a network 390, a remote STT service 360, a hosting environment 371, and two instances (Facility “A” 301, Facility “B” 331) of a contextual STT platform configured in accordance with the teachings of this disclosure. The remote STT service 360, the hosting environment 371, and the instances of the contextual STT platform are connected to the network 390 for remote communication.

In accordance with the disclosure, remote STT service 360 is a cloud-based Speech-To-Text service that exposes a remote Application Programming Interface (API) 361 to enable remote computing devices to make use of the remote STT service 360. The remote STT service 360 further includes a standard vocabulary 363 that includes a data store of words that the remote STT service 360 is capable of identifying from spoken language recordings. An STT engine 365 represents the programming and faculties employed by the remote STT service 360 to perform the STT recognition functions. Examples of conventional remote STT services include those offered by Google, Inc., Microsoft Corporation, and others.

Facility “A” 301 represents an exemplary work environment, such as an industrial plant or any other environment where workers perform tasks that may be related by a particular industry or enterprise. Facility “A” 301 includes, for illustrative purposes, a repository 305 of documents and things (also referred to colloquially as “knowledge”) that embody the lexicon of the particular industry or enterprise with which Facility “A” is associated. Examples of such documents and things may be work orders, invoices, business mission documents, inventory documents, training manuals, and any other documents and things which reflect the lexicon of the industry with which Facility “A” 301 is associated. Included within repository 305 may be a computerized maintenance management system (CMMS 307), for example, that is used by workers within Facility “A” 301.

Implemented within Facility “A” 301 is one instance of a contextual STT platform 311 configured in accordance with this disclosure. The contextual STT platform 311 interfaces with the knowledge repository 305 and enables users to submit user data 312, which may include recorded or live-streamed audio as well as user feedback information. The STT platform 311 also includes an STT engine 314 that implements the software functions and logic to accomplish the various tasks and operations detailed here. In short, the STT engine 314 is a logical construct that represents the “brain” of the STT platform 311 and is responsible for performing or causing to be performed the various tasks and functions necessary to carry out the operations of the STT platform 311.

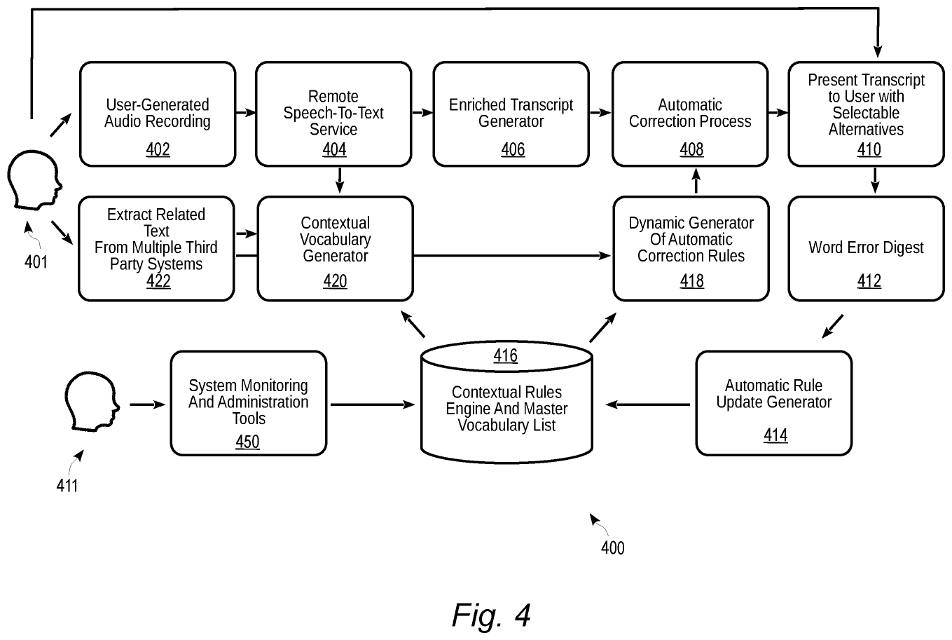

Also included in the STT platform 311 is a contextual vocabulary 316 that represents words or other terms that are specific to the lexicon of the enterprise with which Facility “A” 360 is associated. As is described in greater detail below in conjunction with FIG. 4, the contextual vocabulary 316 may be created by analyzing the knowledge repository 305 of Facility “A” 360 to identify words and terms that are used in the enterprise of Facility “A” 360. In addition, the contextual vocabulary 316 may be further refined by specific user input (user data 312). Still further, a machine learning (ML) facility 318 may be implemented within the STT platform 311 which analyzes the knowledge repository 305 as well as the user data 312 to further refine the contextual vocabulary 316. User data 312 includes audio recordings as well as user feedback, such as user feedback concerning errors identified in any transcripts of those audio recordings.

Facility “B” 331 represents a another exemplary work environment in another industry or enterprise different from Facility “A” 301. Facility “B” 331 similarly includes another instance of the STT platform 341 complete with a different knowledge repository 335 and another contextual vocabulary 345. However, in accordance with the disclosure, the knowledge repository 335 reflects a different lexicon than knowledge repository 305 because Facility “B” 331 is in a different industry or enterprise than Facility “A” 301 and, therefore, includes various other context-specific words and phrases used in that different industry or enterprise. Accordingly, audio recordings submitted to the remote STT service 360, together with supplemental vocabulary data, could return a slightly different transcript than if they were submitted from Facility “A” 301.

Finally, the various components of contextual STT platforms 311 and 341 are illustrated as being resident within the premises of their respective facilities (i.e., Facility “A” 301, Facility “B” 331). However, it will be appreciated that those components could reside at a hosted service 371 accessible over the network 390. In such an embodiment, the contextual STT platforms could be maintained by operators of the hosted service 371 while being made remotely available to the enterprises at Facility “A” 301 and Facility “B” 331. Implementing such hosted environments is within the capabilities of those skilled in the art.

Very generally stated, in operation, the components shown in FIG. 3 operate as follows. The STT engine 314, perhaps in cooperation with the ML facility 318, evaluates the knowledge repository 305 of Facility “A” 301 to identify the contextual vocabulary 316 consistent with the specific lexicon of the enterprise of Facility “A” 301. As a user at Facility “A” 301 works with the system, an audio recording 312 (a voice note or audible work order, for example) is provided to the STT platform 311. The STT engine 314 packages the audio recording 312 together with content from the contextual vocabulary 316 and transmits that information to the remote STT service 360 over the network 390. The content from the contextual vocabulary 316 may take the form of supplemental vocabulary words to be used by the remote STT service 360 when performing speech recognition on the audio recording 312.

Once complete, the remote STT service 360 returns one or more proposed transcripts of the audio recording to the STT engine 314, which may present it (them) to the user for confirmation. In addition, the STT engine 314 may perform additional processing on the proposed transcripts with reference to the contextual vocabulary 316 to further refine the transcripts. For example, the STT engine 314 may compare words in the proposed transcripts with content in the contextual vocabulary 316 to identify, for example, preferred synonyms (e.g., “pallet” versus “palette”), acronyms (e.g., “TechA123”) or other word choices preferred in the lexicon of Facility “A” 301. Once finalized, the corrected transcript may be stored in conjunction with the particular task that originated the audio recording. In addition, the corrected transcript may be stored into the knowledge repository 305 for further refinement.

Advantages and benefits of the particular components and functions introduced in conjunction with FIG. 3 will now be further developed in the context of a workflow that may be implemented by various embodiments of the disclosure.

FIG. 4 is a functional diagram generally illustrating a workflow 400 of operations in accordance with various preferred embodiments. In accordance with the disclosure, the workflow 400 is implemented in a work environment where individuals (e.g., technicians, shop workers, or the like) work in a common environment providing a service to an enterprise. In one example, the workflow 400 may be implemented in an industrial plant with manufacturing equipment. Various technicians may operate and/or maintain the equipment at the plant. It will be appreciated that the particular operations illustrated in FIG. 4 are presented as an example STT task performed in the context of a particular enterprise or industry having its own industry-specific lexicon.

At operation 422, the contextual STT platform extracts text from multiple systems employed by the enterprise. As discussed above, the multiple systems may take the form of a knowledge repository of documents and things (e.g., work orders, invoices, technical documents, manuals, and the like) created and/or used by the enterprise and reflect an industry-specific lexicon for the enterprise. Generally stated, the knowledge repository corresponds to a context within which new STT tasks are performed.

At operation 420, a contextual vocabulary is generated from the data extracted at operation 422. At this operation, the contextual STT platform evaluates the data and determines the frequency of terms occurring in the knowledge repository. In one embodiment, this operation may be implemented using an automatic script that operates periodically to re-create the context of each vocabulary word. A contextual encoding scheme data structure may hold these results to be evaluated at the time of interaction with a new STT task (referencing company, facility, etc. against the frequency of each vocab term happening in these contexts). User-override of the context is also possible, allowing a user to specify words that should always be included in a desired context.

At operation 402, a user 401 captures an audio recording of the user dictating information for use by the enterprise (e.g., a worker speaking an industrial work order aloud for a given company, facility, job, etc.). In various embodiments, the user 401 may employ a mobile device such as a smartphone or the like, to capture audio recordings.

At operation 404, the audio recording is transmitted to a remote STT service in combination with contextual vocabulary information from the contextual vocabulary (operation 420). At this stage, the contextual STT platform uses context elements (company, facility, job, etc.) to choose vocabulary words and/or phrases most likely to appear in this context. The most likely words are used to fill out a limited-size vocabulary list that is then sent to a remote STT service. Optionally, this operation can also be driven by a secondary Machine Learning (ML) system, trained to take in the contextual elements and produce a word list minimizing total length while maximizing the words covered by that list. For example, at a certain company, at a certain facility, for a specific job, the term “SlawNic23” may be very relevant and should be selected, whereas in most situations the word would be meaningless.

At operation 406, one or more transcripts returned from the remote STT service are evaluated to prepare a “suggested” transcript. The preferred embodiment of this component takes the (often multiple) outputs from the remote SIT system, and synthesizes them into a single suggested transcript, with alternative suggested words. This may be accomplished by parsing the remote SIT service results to generate alternative words in places where the proposed transcripts differ from one another. The preferred embodiment of this component takes the output from the SIT system and applies word/phrase corrections specified by the user or a Machine Learning (ML) model, using the same contextual system as the vocabulary generation model described above. This allows terms that are commonly incorrect (e.g., common mishearings or homophones) to be corrected before the suggested transcript is delivered to the user. For example, the term “pallet” would always be preferred to “palette” at a hardware store, while this is not necessarily true at an art supply store. This operation converts the whole-phrase alternatives provided by the remote SIT service into a single transcript with substring alternatives.

At operation 408, an automatic correction process occurs in which alternative words in the suggested transcript may be replaced with more likely alternatives. Operation 408 seeks to identify a most-appropriate alternative from a list of alternatives in a suggested transcript. The preferred embodiment of this component operates using the same context-aware data structure as the vocabulary generation model described above. Here the frequency of the word to be replaced, and the one to replace it with, are both maintained, and the “contextual chooser” phase chooses word replacements likely to be valid while not resulting in significant loss of desired terms.

At operation 410, the suggested transcript is presented to the user for feedback. The user may be presented with the corrected suggested transcript so that any errors may be manually corrected and the transcript approved by the user. In this way, additional user confirmation of the results of the STT recognition may be captured for use in improving future STT recognitions.

At operation 412, a Word Error Digest is created. In the preferred embodiment, the Word Error Digest is created from any alterations to the transcript made by the user at operation 410. The Word Error Digest includes the transcripts (suggested and corrected) as well as the context of the transcription (industry, company, facility, job, individual, etc.), specific phrases that change between them, and tallies of errors. The Word Error Digest may be interrogated by additional analysis techniques to improve the method by potentially adding phrases to the contextual vocabulary list, or by automatically replacing words (e.g., common mishearings like “RF ID” rather than “RFID”).

At operation 414, the Word Error Digest created at operation 412 is used to help formulate updates to a set of contextual rules employed to create the contextual vocabulary. In other words, the Word Error Digest is used to refine rules that are used to identify preferred words for use in the contextual vocabulary so that the actual user feedback may improve word selection in the contextual vocabulary.

Operation 416 represents the contextual rules engine and master vocabulary list builder. At operation 416, various functions, such as machine learning algorithms, may be employed to evaluate context-specific data to identify context-specific words and/or terms that may be stored in the contextual vocabulary. Over time, as additional user feedback is incorporated, the contextual vocabulary enables vastly improved STT recognition for the particular context of the workflow 400.

At operation 450, an administrator 411 is provided with system monitoring and administration tools for administration of the contextual STT platform. Such monitoring and administration tools may include functionality to enable manual alterations to the contextual vocabulary (operation 416), revisions to the contextual rules, maintenance on the contextual STT platform, and the like. These and many other alternatives will be apparent to those skilled in the art.

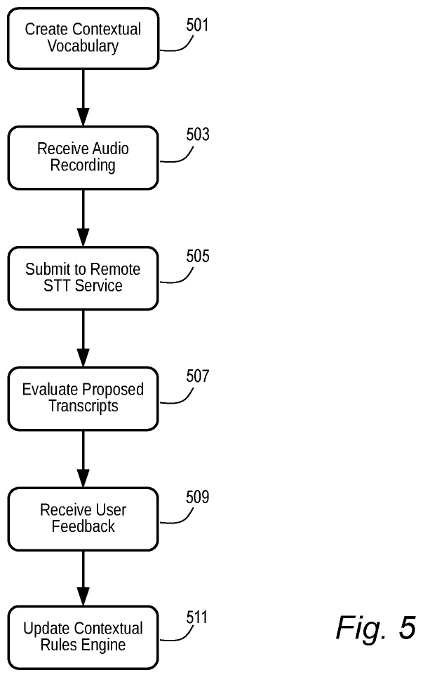

FIG. 5 is a flow diagram illustrating in general terms a process performed by various embodiments to accomplish contextual SIT recognition, in accordance with the disclosure. The process is performed by a contextual STT platform implemented within an enterprise having its own industry-specific lexicon.

At step 501, the process 500 begins by creating a contextual vocabulary. The contextual vocabulary may be created by analyzing a knowledge repository that reflects various documents and things indicative of the language common to a particular enterprise.

At step 503, the process 500 receives an audio recording that represents an STT task, such as a user dictating a message in furtherance of some task being performed on behalf of the enterprise. In one example, the message may be a note or other annotation to a work order. Many other examples are possible.

At step 505, the process 500 submits the audio recording and content from the contextual vocabulary to a remote STT service. In one embodiment, the content from the contextual vocabulary comprises a supplemental vocabulary list submitted with the audio recording for processing by the remote STT service.

At step 507, the process 500 evaluates one or more proposed transcripts for the audio recording received from the remote STT service. In one embodiment, evaluating the proposed transcripts comprises comparing particular words in the proposed transcripts with the contextual vocabulary to identify preferred alternative words. Substituting preferred words in the proposed transcripts results in a suggested transcript.

At step 509, the process 500 receives user feedback on the suggested transcript that identifies actual errors in the STT recognition process. The user feedback can be used to compile a Word Error Digest that identifies discrepancies between the suggested transcript and an accepted transcript.

At step 511, the contextual vocabulary may be updated to reflect the corrections to the transcript to improve performance of the system. A machine learning facility may be implemented to improve a contextual rules engine used to compile the contextual vocabulary.

An advantage of the disclosed contextual STT platform is that transcriptions become significantly more accurate in specific contexts requiring specific vocabulary. For example, below is a comparison of likely transcriptions between conventional STT systems and Genba that demonstrates the significant loss of meaning with a conventional system in an industrial manufacturing facility:
Unenhanced STT system: I replaced the RF ID on slaw Nicks twenty-three from the new palette and closed the reorder.
Genba platform: I replaced the RFID on SlawNic23 from the new pallet and closed the work order.

It should be understood that arrangements described herein are for purposes of example only. As such, those skilled in the art will appreciate that other arrangements and other elements (e.g., machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only and is not intended to be limiting.

What is claimed is:

1. A system for contextual speech-to-text (STT) recognition, comprising:
a memory;
a data storage component;
a network communication component; and
a processor configured to execute components in the memory, the components including:
a contextual vocabulary compiled by evaluating a knowledge repository that includes words appearing disproportionately in use in a particular enterprise, and
an STT engine configured to transmit an audio recording and content from the contextual vocabulary over the network communication component to a remote STT service, to evaluate one or more proposed transcripts of the audio recording returned by the remote STT service, and to prepare a suggested transcript of the audio recording,
wherein the suggested transcript of the audio recording reflects at least a portion of the content from the contextual vocabulary.

2. The system recited in claim 1, wherein the STT engine is further configured to prepare the suggested transcript of the audio recording by analyzing the one or more proposed transcripts in view of the contextual vocabulary to select from a plurality of alternative proposed transcripts.

3. The system recited in claim 1, wherein the STT engine is further configured to present the suggested transcript to a user for feedback.

4. The system recited in claim 3, wherein the user feedback comprises an identification of an error in the suggested transcript.

5. The system recited in claim 4, wherein the STT engine is further configured to update a contextual rules engine to reflect the error identified in the suggest transcript.

6. The system recited in claim 1, wherein the components further comprise a machine learning (ML) facility trained to produce a word list that minimizes total length while maximizing; words derived from the contextual vocabulary.

7. The system recited in claim 1, wherein the system is configured to execute in cooperation with an enterprise that has an industry-specific lexicon.

8. A method for contextual speech-to-text (STT) recognition, comprising:
creating a contextual vocabulary by evaluating a knowledge repository associated with an enterprise, the enterprise having a specialized lexicon;
receiving an audio recording representing an STT task;
submitting to a remote STT service the audio recording and content derived from the contextual vocabulary;
evaluating one or more proposed transcripts received from the remote STT service to identify alternative words that match the contextual vocabulary to create a suggested transcript; and
presenting the suggested transcript for use in connection with the STT task.

9. The method recited in claim 8, further comprising received user feedback identifying one or more errors in the suggested transcript.

10. The method recited in claim 9, further comprising updating the suggested transcript to correct the errors to create a final transcript.

11. The method recited in claim 10, further comprising storing the final transcript in the knowledge repository.

12. The method recited in claim 8, wherein the audio recording is received from a worker employed by the enterprise.

13. The method recited in claim 8, wherein the remote STT service comprises a cloud-based SIT service based on a general vocabulary.

14. The method recited in claim 8, further comprising updating a contextual rules engine to reflect the evaluation of the one or more proposed transcripts.

15. The method recited in claim 8, wherein creating the contextual vocabulary further comprises executing a machine learning model to identify a frequency of occurrence of words in the knowledge repository.
